(19) United States
(12) Patent Application Publication
(10) Pub. No.: US 2026/0054981 A1
(43) Pub. Date: Feb. 26, 2026

(54) METHOD AND SYSTEM FOR HYDROGEN PRODUCTION

(71) Applicant: SAUDI ARABIAN OIL COMPANY, Dhahran (SA)

(72) Inventors: Hanaa ALSOMALI, Dhahran (SA); Hatim ASEERI, Dhahran (SA); Bandar Jubran ALQAHTANI, Dhahran (SA)

(73) Assignee: SAUDI ARABIAN OIL COMPANY, Dhahran (SA)

(21) Appl. No.: 18/811,514

(22) Filed: Aug. 21, 2024

(51) Int. Cl. C01B 3/06; C01B 3/50

(52) U.S. Cl. CPC C01B 3/06; C01B 3/508; C01B 2203/0475; C01B 2203/1241

(57) ABSTRACT

A method for hydrogen production may comprise: feeding a steam stream and a natural gas stream to a methane reforming unit to produce a gray hydrogen gas and CO₂ stream; feeding the gray hydrogen and CO₂ stream to a CO₂ capture unit to produce blue hydrogen; feeding a water stream and electricity to an electrolyzer unit to produce a green hydrogen gas and oxygen; and collecting the blue hydrogen from the CO₂ capture unit and the green hydrogen from the electrolyzer unit. A hydrogen production system may comprise: a methane reforming unit; a CO₂ capture unit; and an electrolyzer.

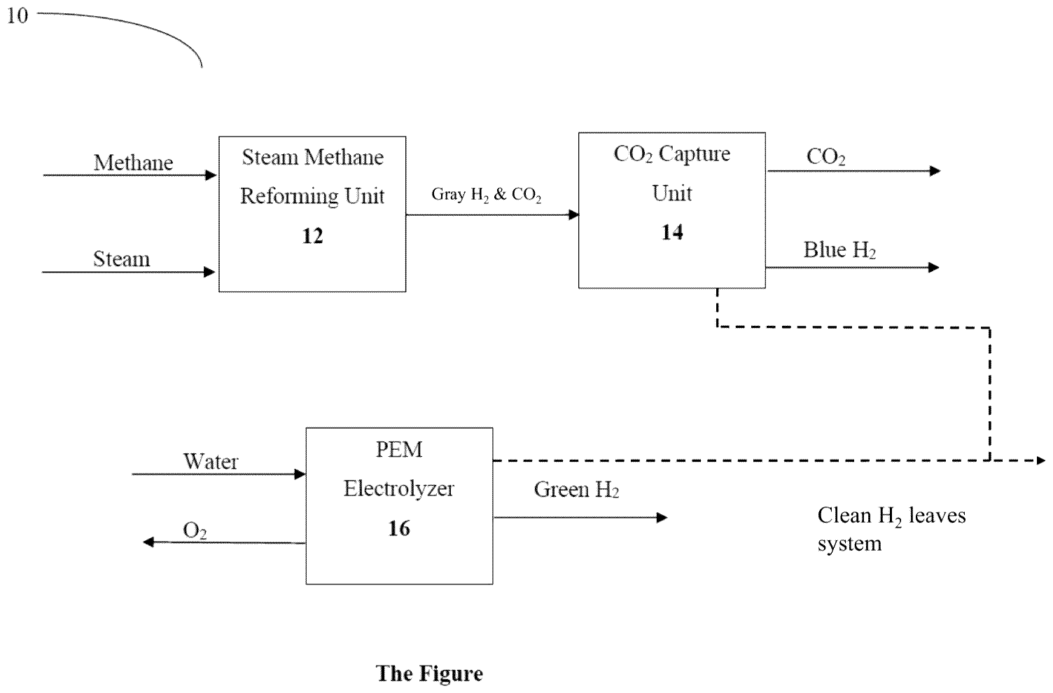

### FIELD

The present disclosure generally relates to methods and systems for production of blue and green hydrogen.

### BACKGROUND

Hydrogen production stands at the forefront of the transition towards renewable energy and the decarbonization of the oil and gas downstream sector. As a versatile energy carrier, hydrogen holds significant potential to reduce carbon footprints when produced with low carbon dioxide emissions. Traditional methods of hydrogen production, such as steam methane reforming (SMR), are carbon-intensive, releasing substantial amounts of carbon dioxide. Advancements in technology are paving the way for greener alternatives like electrolysis, but electrolysis typically is cost inefficient.

By leveraging clean energy sources, green hydrogen can be produced, which is not only environmentally friendly but also aligns with global decarbonization objectives. This approach helps mitigate the environmental impact of the oil and gas downstream sector, traditionally known for its greenhouse gas emissions. Economically feasible hydrogen production with low carbon dioxide emissions requires innovative solutions and substantial investments. Therefore, it is desirable to produce hydrogen in a cost-efficient manner using renewable energy.

### SUMMARY

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In one or more aspects, the present disclosure provides a method for hydrogen production comprising: feeding a steam stream and a natural gas stream to a methane reforming unit to produce a gray hydrogen gas and CO₂ stream; feeding the gray hydrogen and CO₂ stream to a CO₂ capture unit to produce blue hydrogen; feeding a water stream and electricity to an electrolyzer unit to produce a green hydrogen gas and oxygen; and collecting the blue hydrogen from the CO₂ capture unit and the green hydrogen from the electrolyzer unit.

In another aspect, the present disclosure provides a system for hydrogen production comprising: a methane reforming unit; a CO₂ capture unit; and an electrolyzer.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWING(S)

The FIGURE shows a schematic diagram of an embodiment of a system and method of the present disclosure.

### DETAILED DESCRIPTION

The present disclosure generally relates to methods and systems for production of blue and green hydrogen.

The methods and systems of this disclosure utilize steam reformation and water electrolysis to aid in decarbonizing the oil and gas downstream sector. The methods and systems of this disclosure produce hydrogen at low cost and with low carbon dioxide emissions.

The present disclosure provides two methods for hydrogen production. The first method is steam methane reforming and the second is proton exchange membrane (PEM) electrolysis.

A steam methane reforming unit operates by using high-temperature steam (700° C.-1,000° C.) to produce hydrogen from a methane source, such as natural gas. In steam-methane reforming, methane reacts with steam under 3-25 bar pressure (1 bar=14.5 psi) in the presence of a catalyst to produce hydrogen, carbon monoxide, and a relatively small amount of carbon dioxide. Steam reforming is endothermic—that is, heat must be supplied to the process for the reaction to proceed. The basic reaction for steam-methane reforming is: CH₄+H₂O (+heat)→CO+3H₂. Subsequently, in what is called the “water-gas shift reaction,” the carbon monoxide and steam are reacted using a catalyst to produce carbon dioxide and more hydrogen. The basic reaction for this process is CO+H₂O→CO₂+H₂ (+small amount of heat). After the hydrogen and carbon dioxide is produced, it can be further treated to separate the hydrogen from the carbon dioxide. This process is generally known as “pressure-swing adsorption.” In pressure swing adsorption, carbon dioxide and other impurities are removed from the gas stream, leaving essentially pure hydrogen. In some embodiments, a pressure swing adsorption unit is part of a steam methane reforming unit to ensure the production of high purity grey hydrogen.

Proton exchange membrane (PEM) electrolysis is the electrolysis of water in a cell equipped with a solid polymer electrolyte (SPE) that is responsible for the conduction of protons, separation of product gases, and electrical insulation of the electrodes. Essentially, water is fed to the anode where the proton then passes through the membrane to the cathode that releases the proton (hydrogen) while the separated oxygen is released back out of the anode. PEM electrolysis is a technique for high purity and efficient hydrogen production since it emits only oxygen as a by-product without any carbon emissions.

Turning to the FIGURE, the FIGURE shows hydrogen production system 10. Hydrogen production system 10 that includes a steam methane reforming unit 12, a CO₂ capture unit 14, and a PEM electrolyzer 16. Methane and steam are fed to the steam methane reforming unit 12 where, in the presence of a catalyst the methane and steam are transformed into blue hydrogen and carbon dioxide. The hydrogen and carbon dioxide are then treated in the CO₂ capture unit 14 to produce a CO₂ stream and a blue hydrogen stream. CO₂ capture unit 14 may be capable of capturing carbon dioxide and carbon monoxide and streaming out the separated blue hydrogen. The phrase “carbon compounds,” and grammatical variations thereof, refers to carbon dioxide and carbon monoxide. CO₂ capture unit 14 may remove carbon compounds via chemical absorption, physical absorption, pressure swing adsorption, membrane separation, adsorption, cryogenic distillation, the like, or combinations thereof. Alternatively, removing carbon compounds via pressure swing adsorption may occur in steam methane reforming unit 12. A solvent may be streamed to CO₂ capture unit 14 for removing carbon compounds. The solvent may be used in chemical absorption, physical absorption, or both. The CO₂ produced and captured in hydrogen production system 10 may be used as a feedstock in further industrial reactions including Fischer-Tropsch synthesis, injected into a subterranean formation for sequestration, used in enhanced oil recovery techniques, mineralized, the like, or combinations thereof.

In order to produce a greater amount of hydrogen [have a decarbonized source], the steam methane reforming unit 12 is used in conjunction with PEM electrolyzer 16. As noted above, a PEM electrolyzer uses electrolysis to separate water into green hydrogen and oxygen. The green hydrogen from PEM electrolyzer 16 does not flow through CO₂ capture unit 14. Hydrogen production system 10 serves as a decarbonized source of hydrogen to decarbonize this sector of the oil and gas industry. Further, as hydrogen is an important feedstock for industrial reactions, if one of PEM electrolyzer 16 and steam methane reforming unit 12 are not producing or down for maintenance/modification, the other can still provide hydrogen. This adds resiliency and reliability to hydrogen production system 10.

The blue hydrogen and green hydrogen stream can then optionally be combined (shown in dashed line) and used wherein in the facility hydrogen is needed, or it may be sold. The blue and green hydrogen may be used as a feedstock in further downstream and industrial reactions including Fischer-Tropsch synthesis.

In preferred embodiments, PEM electrolyzer 16 may be powered by a solar energy plant. The solar energy plant may include photovoltaic arrays, a controller, and a battery system. The photovoltaic arrays may use monocrystalline silicon (Si-mono), polycrystalline silicon, various thin-film solar cells, perovskite solar cells, organic photovoltaic cells, gallium cells, quantum dot solar cells, the like, or combinations thereof. The controller may be a DC-DC converter, buck converter, boost converter, buck-boost converter, Maximum Power Point Tracking (MPPT) controllers, Pulse Width Modulation (PWM) controllers, the like, or combinations thereof. The battery system may include lithium-ion batteries or other known battery types used with photovoltaic arrays. The battery may store charge generated by the photovoltaic arrays.

The present disclosure is further directed to the following non-limiting clauses:

Clause 1: A method for hydrogen production comprising: feeding a steam stream and a natural gas stream to a methane reforming unit to produce a gray hydrogen gas and CO₂ stream; feeding the gray hydrogen and CO₂ stream to a CO₂ capture unit; feeding a water stream and electricity to an electrolyzer unit to produce hydrogen and oxygen; and collecting the hydrogen from the CO₂ capture unit and the electrolyzer unit.

Clause 2: The method of clause 1, wherein the CO₂ capture unit performs at least one of chemical absorption and physical absorption.

Clause 3: The method of clauses 1 or 2, wherein the electrolyzer comprises a proton exchange membrane.

Clause 4: The method of any of clauses 1-3, wherein the electrolyzer is powered by a solar energy plant.

Clause 5: The method of clause 4, wherein the solar energy plant comprises a battery system.

Clause 6: The method of clause 5, wherein the solar energy plant further comprises a DC-DC converter.

Clause 7: The method of any of clauses 4-6, wherein the green hydrogen gas is not flowed to the CO₂ capture unit.

Clause 8: A hydrogen production system comprising: a methane reforming unit; a CO₂ capture unit; and an electrolyzer.

Clause 9: The system of clause 8, wherein the CO₂ capture unit performs at least one of chemical absorption and physical absorption.

Clause 10: The system of clauses 8 or 9, wherein the electrolyzer comprises a proton exchange membrane.

Clause 11: The system of any of clauses 8-10, wherein the electrolyzer is powered by a solar energy plant.

Clause 12: The system of clause 11, wherein the solar energy plant comprises a battery system.

Clause 13: The system of clause 12, wherein the solar energy plant further comprises a DC-DC converter.

Clause 14: The system of any of clauses 11-13, wherein the electrolyzer produces green hydrogen gas and the green hydrogen gas is not flowed to the CO₂ capture unit.

### Examples

To facilitate a better understanding of the embodiments of the present disclosure, the following examples of preferred or representative embodiments are given. In no way should the following examples be read to limit, or to define, the scope of the invention.

Aspen HYSYS V11 software was used to model a hydrogen producing system including a steam methane reformation unit and a PEM electrolyzer. Below are parameters and values for the PEM electrolyzer model.

TABLE 1

| Variable | Value | Unit |
|---|---|---|
| Electrolyzer Cell Temperature | 80 | ° C. |
| Average Vₙₑᵣₙₛₜ | 1.18037 | V |
| Operating Voltage | 2.51514 | V |
| Cell/Stack Current | 66.7389 | A |
| Hydrogen Gas Produced Per Cell | 0.000344566 | gmole/s |
| Required Number of Cell | 2.00E+06 | |
| Electrical Work Per Cell/Stack | 0.167858 | kW |
| Total Electrical Work | 335716 | kW |
| Electrolyzer Efficiency | 58.7 | % |
| Energy Demand | 67 | kWh/kgH2 |
| Hydrogen lower heating | 2.86e+005 | kJ/kmol |
| value (LCV) | | |
| Hydrogen production rate | 5000 | kg/hr |
| De-ionized freshwater consumption | 46840 | kg/hr |

The model was designed to support an oil and gas refinery with a typical capacity of 300 thousand barrels per day processing Arab Light Crude. The model assumed that the refinery would require 300 tons/day of hydrogen.

Further, the performance of the PEM electrolyzer was evaluated according to the current-voltage characteristics of an electrolytic cell.

$${E}_{cell}^{0} = 1.23 - 0.9 \times {10}^{- 3} ( T - 298 ) + \frac{RT}{4 F} ln \text{?} ( \begin{matrix}{p}_{\underline{H 2}}^{2} \cdot {p}_{\underline{O 2}} \\ {p}_{H 2 O}\end{matrix} )$$

$${V}_{cell} = {E}_{cell}^{0} + I \text{?} \times \text{?} R$$

$${P}_{cell} = {V}_{cell} \text{?} \times \text{?} I$$

$${P}_{Stack} = {N}_{cell} \text{?} \times \text{?} {P}_{cell}$$

$${N}_{H 2} = \begin{matrix}JA \\ 2 F\end{matrix} -$$

$${N}_{O 2} = \begin{matrix}JA \\ 4 F\end{matrix} -$$

$$η = \text{?} \begin{matrix}{LCV}_{H 2} \underline{\text{?} {N}_{H 2} \text{?}} \\ {P}_{Stack}\end{matrix}$$

$$\text{?} \text{indicates text missing or illegible when filed}$$

The electrolyzer was modeled to produce 50 tons/day of hydrogen; this required an electricity input of 336 MWh. The 50 tons/day of hydrogen constituted 17% of the total hydrogen production of the hydrogen producing system.

PVSyst simulator software was used to model a solar energy plant to provide electricity to the PEM electrolyzer. The solar energy plant was modeled for a photovoltaic array and a battery pack to supply electricity to the PEM electrolyzer. Below are parameters and values for the solar energy plant model.

TABLE 2

| | Photovoltaic Array | | Battery Pack | |
|---|---|---|---|---|
| System Information | Technology | Si-mono | Technology | Lithium-ion |
| | Controller | DC-DC | Number of | 75000 |
| | | converter | units | |
| | Number of | 943000 | Capacity | 5600000 Ah |
| | modules | | | |
| | Pₙₒₘ | 700 Wp | Stored | 3628800.0 KWh |
| | | | energy | |
| | Tilt angle | 28.1 | Lifetime | 10 years |
| | Module area | 2929290 m² | | |
| Levelized Cost of | 0.0154 | | | |
| Electricity (LCOE) | USD/KWh | | | |

The solar energy plant was modeled to include a battery system capable of sustaining continuous stable production of 336 MWh electricity for the electrolyzer.

After modeling, a levelized cost of hydrogen (LCOH) method was used to evaluate the performance of the hydrogen producing system. The parameter values of the above tables produced a LCOH of $1.65 USD and an 88% reduction of carbon dioxide emissions compared to standard steam methane reformation.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related, and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is the following:

1. A method for hydrogen production comprising:
feeding a steam stream and a natural gas stream to a methane reforming unit to produce a gray hydrogen gas and CO₂ stream;
feeding the gray hydrogen and CO₂ stream to a CO₂ capture unit to produce blue hydrogen;
feeding a water stream and electricity to an electrolyzer unit to produce a green hydrogen gas and oxygen; and
collecting the blue hydrogen from the CO₂ capture unit and the green hydrogen from the electrolyzer unit.

2. The method of claim 1, wherein the CO₂ capture unit performs at least one of chemical absorption and physical absorption.

3. The method of claim 1, wherein the electrolyzer comprises a proton exchange membrane.

4. The method of claim 1, wherein the electrolyzer is powered by a solar energy plant.

5. The method of claim 4, wherein the solar energy plant comprises a battery system.

6. The method of claim 5, wherein the solar energy plant further comprises a DC-DC converter.

7. The method of claim 4, wherein the green hydrogen gas is not flowed to the CO₂ capture unit.

8. A hydrogen production system comprising:
a methane reforming unit;
a CO₂ capture unit; and
an electrolyzer.

9. The system of claim 8, wherein the CO₂ capture unit performs at least one of chemical absorption and physical absorption.

10. The system of claim 8, wherein the electrolyzer comprises a proton exchange membrane.

11. The system of claim 8, wherein the electrolyzer is powered by a solar energy plant.

12. The system of claim 11, wherein the solar energy plant comprises a battery system.

13. The system of claim 12, wherein the solar energy plant further comprises a DC-DC converter.

14. The system of claim 11, wherein the electrolyzer produces green hydrogen gas and the green hydrogen gas is not flowed to the CO₂ capture unit.
